(19) United States
(12) Patent Application Publication
(10) Pub. No.: US 2025/0368078 A1
(43) Pub. Date: Dec. 4, 2025

(54) METHOD OF MANAGING THE SUPPLY OF ELECTRICAL ENERGY IN A VEHICLE, CONTROL ARRANGEMENT, AND VEHICLE

(71) Applicant: Scania CV AB, Södertälje (SE)

(72) Inventor: Mikael Nivala Fernberg, Stockholm (SE)

(21) Appl. No.: 18/870,352

(22) PCT Filed: Jun. 12, 2023
(86) PCT No.: PCT/SE2023/050581

§ 371 Date: Nov. 27, 2024

(30) Foreign Application Priority Data
Jun. 30, 2022 (SE) 2250819-6

(51) Int. Cl. B60L 53/62; B60L 1/00; B60L 50/60; B60L 58/20

(52) U.S. Cl. CPC B60L 53/62; B60L 1/003; B60L 50/60; B60L 58/20; B60L 2210/10

(57) ABSTRACT

A method of managing the supply of electrical energy in a vehicle is disclosed, wherein the vehicle comprises an electric propulsion system and a high voltage electrical system configured to provide electricity to the electric propulsion system. The high voltage electrical system further comprises a number of propulsion batteries and an electrical connector. The method comprises the steps of, when the electrical connector 0 is electrically connected to an external electric power source and the number of propulsion batteries is disconnected from the high voltage electrical system, performing a pre-charge of the high voltage electrical system, and then supplying electricity from the external electric power source to at least one high voltage vehicle component of the vehicle. The present disclosure further relates to a computer program, a computer-readable medium, a control arrangement, and a vehicle.

### TECHNICAL FIELD

The present disclosure relates to a method of managing the supply of electrical energy in a vehicle. The present disclosure further relates to a computer program, a computer-readable medium, a control arrangement, and a vehicle.

### BACKGROUND

The use of electric drive for vehicles provides many advantages, especially regarding local emissions. Such vehicles comprise one or more electric propulsion motors configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

The electricity is usually stored in a number of propulsion batteries each comprising a number of rechargeable battery cells. Some different types of battery cells are used, such as lithium-ion battery cells, lithium polymer battery cells, as well as other types of rechargeable battery cells.

An at least partially electric vehicle, such as a pure electric vehicle and a hybrid electric vehicle, normally comprises a high voltage electrical system and a low voltage electrical system, wherein the high voltage electrical system is configured to provide electricity from the propulsion batteries to the electric propulsion system as well as to a number of high voltage vehicle components during operation of the vehicle, whereas the low voltage system is configured to provide electricity to a number of low voltage components of the vehicle.

A low voltage electrical system of a vehicle can be regarded as an electrical system of a vehicle having a nominal voltage within the so-called Voltage Class A, usually abbreviated VCA, namely a nominal voltage lower than 60 volts. A high voltage electrical system of a vehicle can be regarded as an electrical system of a vehicle having a nominal voltage within the so-called Voltage Class B, usually abbreviated VCB, namely a nominal voltage equal to, or higher than, 60 volts.

Normally, the propulsion batteries are disconnected from the high voltage electrical system when an at least partially electric vehicle is not in use to increase the safety of the system and to avoid parasitic losses which can reduce a state of charge level of the propulsion batteries.

As indicated above, an at least partially electric vehicle may comprise a number of high voltage vehicle components powered via the high voltage electrical system of the vehicle.

Typically, these high voltage vehicle components normally cannot be used if the propulsion batteries are disconnected from the high voltage electrical system.

Battery cells are costly and large number of battery cells is normally needed to ensure a sufficient available operational range of a vehicle, system voltage and power, especially in heavier types of pure electric vehicles. Therefore, the cost of the propulsion batteries can constitute a large proportion of the final cost of an at least partially electric vehicle.

Moreover, almost all types of battery cells have a limited lifespan, and the number of charge cycles of the battery cells affects the lifespan of the battery cells more than the mere passage of time.

Furthermore, sudden increases in electrical current and voltage in an electrical system can impair the reliability of the electrical system and may have an adverse effect on the lifespan of the electrical system and on electrical components therein.

### SUMMARY

It is an object of the present invention to overcome, or at least alleviate, at least some of the above-mentioned problems and drawbacks.

According to a first aspect of the invention, the object is achieved by a method of managing the supply of electrical energy in a vehicle, wherein the vehicle comprises an electric propulsion system for providing motive power to the vehicle, a number of high voltage vehicle components, and an electrical system, wherein the electrical system comprises:
a high voltage electrical system configured to provide electricity to the electric propulsion system and to the number of high voltage vehicle components during operation of the vehicle,
a number of propulsion batteries, and
an electrical connector,
   wherein the method comprises the steps of, when the electrical connector is electrically connected to an external electric power source and the number of propulsion batteries is disconnected from the high voltage electrical system:
performing a pre-charge of the high voltage electrical system, and then
supplying electricity from the external electric power source to at least one high voltage vehicle component of the number of high voltage vehicle components of the vehicle.

Thereby, a method is provided allowing operation of the at least one high voltage vehicle component in a simple, efficient, and reliable manner using electricity from the external electric power source while circumventing the need for connecting the number of propulsion batteries to the high voltage electrical system.

In this manner, the usage of the number of propulsion batteries can be lowered while allowing a flexible, reliable, and energy efficient operation of the least one high voltage vehicle component using electrical energy from the external electric power source. By circumventing the need for connecting the number of propulsion batteries to the high voltage electrical system, negative effects on the lifespan of the number of propulsion batteries can be avoided.

Furthermore, by performing the pre-charge of the high voltage electrical system, an inrush current during a power up procedure of the high voltage electrical system is limited, which can increase the lifespan of electrical components in the high voltage electrical system and can increase reliability of the high voltage electrical system.

Accordingly, a method is provided overcoming, or at least alleviating, at least some of the above-mentioned problems and drawbacks. As a result, the above-mentioned object is achieved.

Optionally, the step of performing the pre-charge of the high voltage electrical system comprises the step of:
performing the pre-charge of the high voltage electrical system by supplying electricity from the external electric power source to the high voltage electrical system.

Thereby, the pre-charge can be performed in a simple, quick, reliable, and efficient manner without having to connect the number of propulsion batteries to the high voltage electrical system.

Optionally, the electrical system of the vehicle comprises a low voltage electrical system for providing electricity to a number of low voltage vehicle components of the vehicle, a number of low voltage batteries connected to the low voltage electrical system, and an electric voltage converter, and wherein the step of performing the pre-charge of the high voltage electrical system comprises the step of:
performing the pre-charge of the high voltage electrical system by supplying electricity from the low voltage batteries to the high voltage electrical system via the electric voltage converter.

Thereby, the pre-charge can be performed in a simple, safe, reliable, and efficient manner without having to connect the number of propulsion batteries to the high voltage electrical system.

Optionally, the step of supplying electricity from the external electric power source to at least one high voltage vehicle component of the vehicle comprises the steps of:
causing a charging module to operate in a voltage control mode, and
supplying electricity from the external electric power source to at least one high voltage vehicle component of the vehicle via the charging module.

Thereby, a method is provided allowing a stable and energy efficient operation of the least one high voltage vehicle component using electrical energy from the external electric power source. Moreover, the voltage in the high voltage electrical system can be kept substantially constant by the charging module also at varying loads of the number of high voltage vehicle components.

Optionally, the method comprises the step of:
ensuring that the number of propulsion batteries is disconnected from the high voltage electrical system during the step of supplying electricity from the external electric power source to at least one high voltage vehicle component of the vehicle.

Thereby, the usage of the number of propulsion batteries can be lowered to avoid negative effects on the lifespan of the number of propulsion batteries while allowing a flexible, reliable, and energy efficient operation of the least one high voltage vehicle component using electrical energy from the external electric power source.

Optionally, the method comprises the step of:
operating the at least one high voltage vehicle component of the vehicle using electricity supplied from the external electric power source.

Since the method comprises the steps of performing the pre-charge of the high voltage electrical system, and then supplying electricity from the external electric power source to at least one high voltage vehicle component of the vehicle, the least one high voltage vehicle component can be operated in a flexible, reliable, and energy efficient manner while circumventing the need for connecting the number of propulsion batteries to the high voltage electrical system.

According to a second aspect of the invention, the object is achieved by a computer program comprising instructions which, when the program is executed by a computer, cause the computer to carry out the method according to some embodiments of the present disclosure.

Since the computer program comprises instructions which, when the program is executed by a computer, cause the computer to carry out the method according to some embodiments, a computer program is provided which provides conditions for overcoming, or at least alleviating, at least some of the above-mentioned drawbacks. As a result, the above-mentioned object is achieved.

According to a third aspect of the invention, the object is achieved by a computer-readable medium comprising instructions which, when executed by a computer, cause the computer to carry out the method according to some embodiments of the present disclosure. Since the computer-readable medium comprises instructions which, when the program is executed by a computer, cause the computer to carry out the method according to some embodiments, a computer-readable medium is provided which provides conditions for overcoming, or at least alleviating, at least some of the above-mentioned drawbacks. As a result, the above-mentioned object is achieved.

According to a fourth aspect of the invention, the object is achieved by a control arrangement configured to manage the supply of electrical energy in a vehicle, wherein the vehicle comprises an electric propulsion system for providing motive power to the vehicle, a number of high voltage vehicle components, and an electrical system, wherein the electrical system comprises:
a high voltage electrical system configured to provide electricity to the electric propulsion system and to the number of high voltage vehicle components during operation of the vehicle,
a number of propulsion batteries, and
an electrical connector,
   wherein the control arrangement is configured to, when the electrical connector is electrically connected to an external electric power source and the number of propulsion batteries is disconnected from the high voltage electrical system:
perform a pre-charge of the high voltage electrical system, and then
supply electricity from the external electric power source to at least one high voltage vehicle component of the number of high voltage vehicle components of the vehicle.

Thereby, a control arrangement is provided allowing operation of the at least one high voltage vehicle component in an efficient manner using electricity from the external electric power source while circumventing the need for connecting the number of propulsion batteries to the high voltage electrical system.

In this manner, the usage of the number of propulsion batteries can be lowered while allowing a flexible, reliable, and energy efficient operation of the least one high voltage vehicle component using electrical energy from the external electric power source. By circumventing the need for connecting the number of propulsion batteries to the high voltage electrical system, negative effects on the lifespan of the number of propulsion batteries can be avoided.

Furthermore, by performing the pre-charge of the high voltage electrical system, an inrush current during a power up procedure of the high voltage electrical system is limited, which can increase the lifespan of electrical components in the high voltage electrical system and can increase reliability of the high voltage electrical system.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the invention, the object is achieved by a vehicle comprising an electric propulsion system for providing motive power to the vehicle, a number of high voltage vehicle components, and an electrical system, wherein the electrical system comprises:
a high voltage electrical system configured to provide electricity to the electric propulsion system and to the number of high voltage vehicle components during operation of the vehicle,
a number of propulsion batteries,
an electrical connector, and
a control arrangement configured to, when the electrical connector is electrically connected to an external electric power source and the number of propulsion batteries is disconnected from the high voltage electrical system:
perform a pre-charge of the high voltage electrical system, and then
supply electricity from the external electric power source to at least one high voltage vehicle component of the number of high voltage vehicle components of the vehicle

Thereby, a vehicle is provided allowing operation of the at least one high voltage vehicle component in an efficient manner using electricity from the external electric power source while circumventing the need for connecting the number of propulsion batteries to the high voltage electrical system.

In this manner, the usage of the number of propulsion batteries can be lowered while allowing a flexible, reliable, and energy efficient operation of the least one high voltage vehicle component using electrical energy from the external electric power source. By circumventing the need for connecting the number of propulsion batteries to the high voltage electrical system, negative effects on the lifespan of the number of propulsion batteries can be avoided.

Furthermore, by performing the pre-charge of the high voltage electrical system, an inrush current during a power up procedure of the high voltage electrical system is limited, which can increase the lifespan of electrical components in the high voltage electrical system and can increase reliability of the high voltage electrical system.

Accordingly, a vehicle is provided overcoming, or at least alleviating, at least some of the above-mentioned problems and drawbacks. As a result, the above-mentioned object is achieved.

Optionally, the high voltage electrical system comprises a DC link, and wherein the control arrangement is configured to perform the pre-charge of the high voltage electrical system by supplying electricity to the DC link. Thereby, the high voltage electrical system can be pre-charged in a simple and efficient manner.

Optionally, the electrical connector form part of a charging interface for charging the number of propulsion batteries. Thereby, the at least one high voltage vehicle component is allowed to operate in an efficient manner using electricity from the external electric power source while circumventing the need for connecting the number of propulsion batteries to the high voltage electrical system.

Optionally, the number of high voltage vehicle components comprises one or more of:
an electric power take-off component,
a climatization component,
an air compressor,
a servo pump,
a DC/DC converter, and
an electric machine.

Thereby, conditions are provided for operating one or more of such high voltage vehicle components in an efficient manner using electricity from the external electric power source while circumventing the need for connecting the number of propulsion batteries to the high voltage electrical system.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments,

FIG. 2 schematically illustrates an electric propulsion system and an electrical system of the vehicle illustrated in FIG. 1,

FIG. 3 schematically illustrates the electric propulsion system of the vehicle illustrated in FIG. 1 and an electrical system according to some further embodiments,

FIG. 4 schematically illustrates a method of managing the supply of electrical energy in a vehicle, and

FIG. 5 illustrates a computer-readable medium.

### DETAILED DESCRIPTION

Aspects of the present invention will now be described more fully. Like numbers refer to like elements throughout. Well-known functions or constructions will not necessarily be described in detail for brevity and/or clarity.

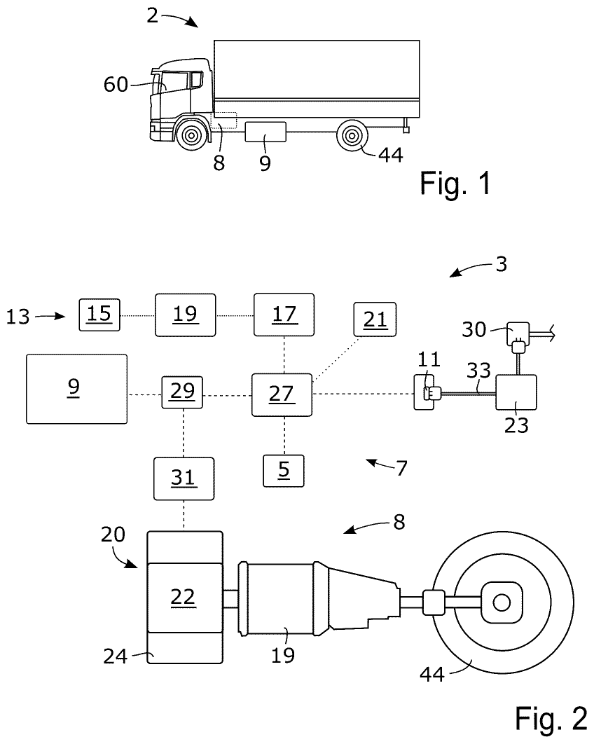

FIG. 1 schematically illustrates a vehicle 2 according to some embodiments. According to the illustrated embodiments, the vehicle 2 is a truck, i.e., a type of heavy road vehicle. According to further embodiments, the vehicle 2, as referred to herein, may be another type of manned or unmanned vehicle for land-based propulsion such as a lorry, a bus, a construction vehicle, a tractor, a car, or the like.

The vehicle 2 comprises an electric propulsion system 8 for providing motive power to the vehicle 2. According to the illustrated embodiments, the electric propulsion system 8 is configured to provide motive power to the vehicle 2 via wheels 44 of the vehicle 2. The vehicle 2 further comprises a number of propulsion batteries 9 configured to provide electricity to the electric propulsion system 8 during operation of the vehicle 2.

FIG. 2 schematically illustrates the electric propulsion system 8 and an electrical system 3 of the vehicle 2 illustrated in FIG. 1. Below, simultaneous reference is made to FIG. 1 and FIG. 2, if not indicated otherwise.

According to the illustrated embodiments, the electric propulsion system 8 comprises an electric propulsion motor 20. The electric propulsion motor 20 of the electric propulsion system 8 is configured to provide motive power to the vehicle 2 via wheels 44 of the vehicle 2. The electric propulsion motor 20 may also be referred to as an electric propulsion machine, or the like.

According to the illustrated embodiments, the electric propulsion system 8 is a pure electric propulsion system and comprises no internal combustion engine. According to further embodiments, the electric propulsion system 8, as referred to herein, may be a so-called hybrid electric propulsion system comprising an internal combustion engine in addition to the electric propulsion motor 20 for providing motive power to the vehicle 2.

In FIG. 2, the electric propulsion system 8 is illustrated as comprising one electric propulsion motor 20. However, the electric propulsion system 8 may comprise more than one electric propulsion motor 20. According to the illustrated embodiments, the electric propulsion system 8 comprises a transmission 19. The transmission 19 is configured to transmit power between the electric propulsion motor 20 and one or more wheels 44 of the vehicle 2.

The electrical system 3 of the vehicle 2 comprises a number of propulsion batteries 9. The number of propulsion batteries 9 is configured to supply electricity to the electric propulsion motor 20 during operation of the vehicle 2. In FIG. 1 and FIG. 2, the vehicle 2 is illustrated as comprising one propulsion battery 9. However, as indicated herein, the vehicle 2 may comprise a larger number of propulsion batteries 9, such as a number between two and twelve, or a number between two and thirty. Each propulsion battery 9 may also be referred to as a propulsion battery pack, wherein the propulsion battery pack may comprise a number of propulsion battery modules each comprising a number of battery cells, such as lithium-ion battery cells, lithium polymer batteries cells, nickel-metal hydride battery cells, or the like.

The electric propulsion motor 20 comprises a rotor 22 and a stator 24. The electric propulsion motor 20 is capable of converting electrical energy into mechanical energy in the form of rotation of the rotor 22. Moreover, the electric propulsion motor 20 may be capable of converting mechanical energy in the form of rotation of the rotor 22 into electrical energy which for example can be stored in the number of propulsion batteries 9. In this manner the electric propulsion motor 20 may provide regenerative braking of the vehicle 2.

According to the illustrated embodiments, the electric propulsion system 8 comprises a power module 31 comprising power electronics. The power module 31 is configured to control the amount of electricity supplied from the number of propulsion batteries 9 to the electric propulsion motor 20.

One of the stator 24 and the rotor 22 may comprise a number of permanent magnets and the other of the stator 24 and the rotor 22 may comprise wire windings. An alternating electric current passed through the wire windings by the power module 31 may cause a torque to be applied to the rotor 22 due to the magnetic interaction between the wire windings and the permanent magnets. During operation of the electric propulsion system 8, the electric current passed through the wire windings may be alternated in a manner following the rotation of the rotor 22. In this manner, a continuous torque can be applied to the rotor 22 during rotation thereof.

The electrical system 3 of the vehicle 2 comprises a high voltage electrical system 7. The high voltage electrical system 7 is configured to provide electricity to the electric propulsion system 8 and to a number of high voltage vehicle components 5 during operation of the vehicle 2. That is, in more detail, the high voltage electrical system 7 is configured to provide electricity from the number of propulsion batteries 9 to the electric propulsion system 8 and to the number of high voltage vehicle components 5 during travel of the vehicle 2.

According to embodiments herein, the high voltage electrical system 7 has a nominal voltage within the so-called Voltage Class B, usually abbreviated VCB, namely a nominal voltage equal to, or higher than, 60 volts. Therefore, the high voltage electrical system 7 may also be referred to as a VCB electrical system of the vehicle 2. Likewise, the number of high voltage vehicle components 5 may also be referred to as a number of VCB components.

According to the illustrated embodiments, the vehicle 2 is illustrated as comprising one high voltage vehicle component 5. However, the vehicle 2 may comprise significantly more high voltage vehicle components 5. The number of high voltage vehicle components 5 may for example comprise one or more of an electric power take-off component, a climatization component, an air compressor, a servo pump, a DC/DC converter, an electric machine, or the like.

The electrical system 3 of the vehicle 2 comprises a number of connection devices 29 capable of connecting and disconnecting the number of propulsion batteries 9 to and from the high voltage electrical system 7. The number of connection devices 29 may comprise one or more contactors, power electronic switches, or the like. The number of connection devices 29 may be controlled to disconnect the number of propulsion batteries 9 from the high voltage electrical system 7 when the vehicle 2 is not in use. In this manner, the safety of the vehicle 2 can be increased and parasitic losses of the number of propulsion batteries 9 can be avoided.

The electrical system 3 of the vehicle 2 further comprises an electrical connector 11 configured to receive electricity from an external electric power source 30, such as an external electric power grid. According to the illustrated embodiments, the electrical connector 11 form part of a charging interface for charging the number of propulsion batteries 9. In more detail, according to the embodiments illustrated in FIG. 2, the electrical connector 11 is configured to be electrically connected to the external electric power source 30 via a charging module 23 and an electric supply cable 33.

In the embodiments illustrated in FIG. 2, the charging module 23 is an external charging module 23 electrically connected to the external electric power source 30. In other words, according to the embodiments illustrated in FIG. 2, the electrical connector 11 is configured to be electrically connected to, and receive electricity from, the external electric power source 30 via the charging module 23. The charging module 23 may also be referred to as a propulsion battery charger, a propulsion battery charging station, or the like. According to the illustrated embodiments, the charging module 23 is configured to receive an alternating current AC from the external electric power source 30 and is configured to convert the alternating current AC to a direct current DC which is supplied to the electrical connector 11 via the electric supply cable 33.

The electrical system 3 of the vehicle 2 further comprises a control arrangement 21. As is further explained herein, the control arrangement 21 is configured to manage the supply of electrical energy in the vehicle 2.

According to embodiments herein, the control arrangement 21 is configured to, when the electrical connector 11 is electrically connected to an external electric power source 30 and the number of propulsion batteries 9 is disconnected from the high voltage electrical system 7, perform a pre-charge of the high voltage electrical system 7, and then supply electricity from the external electric power source 30 to at least one high voltage vehicle component 5 of the vehicle 2. Thereby a control arrangement 21 is provided allowing operation of the at least one high voltage vehicle component 5 in an efficient manner using electricity from the external electric power source 30 while circumventing the need for connecting the number of propulsion batteries 9 to the high voltage electrical system 7.

In this manner, the usage of the number of propulsion batteries 9 can be lowered while allowing a flexible, reliable, and energy efficient operation of the least one high voltage vehicle component 5 using electrical energy from the external electric power source 30. By circumventing the need for connecting the number of propulsion batteries 9 to the high voltage electrical system 7, negative effects on the lifespan of the number of propulsion batteries 9 can be avoided.

Furthermore, by performing the pre-charge of the high voltage electrical system 7, an inrush current during a power up procedure of the high voltage electrical 7 system is limited, which can increase the lifespan of electronic components in the high voltage electrical system 7 and can increase reliability of the high voltage electrical system 7. Moreover, the pre-charge of the high voltage electrical system 7 can reduce electrical hazards which may occur if the integrity of the high voltage electrical system 7 is compromised due to hardware damage or failure. Furthermore, occurrences of arc flashes can be reduced by pre-charging the high voltage electrical system 7.

The pre-charge of the high voltage electrical system 7, as referred to herein, may be performed by restricting a peak current out from a pre-charging power source by slowing down the dV/dT, i.e., by slowing down the timewise rate of change of the voltage. The value for the dV/dT may be given in volts per second. In this manner, while pre-charging, the system voltage of the high voltage electrical system 7 will rise slowly and controllably with a power-up current never exceeding a maximum allowed current. As the circuit voltage of the high voltage electrical system 7 approaches near steady state, then the control arrangement 21 can terminate the pre-charging. According to some embodiments, the control arrangement 21 may be configured to terminate the pre-charging when the circuit voltage of the high voltage electrical system 7 reaches a certain voltage, such as when the circuit voltage of the high voltage electrical system 7 reaches a certain percent of an operating voltage of the high voltage electrical system 7, for example 80%-98% of an operating voltage of the high voltage electrical system 7.

According to embodiments herein, the control arrangement 21 may be configured to detect if the electrical connector 11 is electrically connected to an external electric power source 30 and detect if the number of propulsion batteries 9 is disconnected from the high voltage electrical system 7, and if so perform the pre-charge of the high voltage electrical system 7, and then supply electricity from the external electric power source 30 to at least one high voltage vehicle component 5 of the vehicle 2.

The control arrangement 21 may be configured to detect if the electrical connector 11 is electrically connected to an external electric power source 30 by monitoring electrical quantities of the electrical connector 11 or other part of the high voltage electrical system 7. Moreover, the control arrangement 21 may detect if the number of propulsion batteries 9 is disconnected from the high voltage electrical system 7 by monitoring the state of the number of connection devices 29 and/or by monitoring electrical quantities of a portion of the high voltage electrical system 7.

According to some embodiments of the herein described, the control arrangement 21 may be configured to, after terminating the pre-charging of the high voltage electrical system 7, suppling a voltage to the at least one high voltage vehicle component 5 of the vehicle 2 at a voltage level at least substantially corresponding to an operating voltage of the high voltage electrical system 7.

According to the illustrated embodiments, the high voltage electrical system 7 comprises a DC link 27. According to these embodiments, as is further explained herein, the control arrangement 21 is configured to perform the pre-charge of the high voltage electrical system 7 by supplying electricity to the DC link 27. Moreover, according to these embodiments, the control arrangement 21 is configured to, after terminating the pre-charge of the high voltage electrical system 7, supply a voltage to the at least one high voltage vehicle component 5 of the vehicle 2 by supplying a voltage to the DC link 27 at a voltage level at least substantially corresponding to an operating voltage of the high voltage electrical system 7.

According to some embodiments, the control arrangement 21 is configured to perform the pre-charge of the high voltage electrical system 7 by supplying electricity from the external electric power source 30 to the high voltage electrical system 7. Thereby, the pre-charge can be performed in a simple, reliable, and efficient manner without having to connect the number of propulsion batteries 9 to the high voltage electrical system 7.

According to the embodiments illustrated in FIG. 2, the electrical system 3 of the vehicle 2 comprises a low voltage electrical system 13. The low voltage electrical system 13 is configured to provide electricity to a number of low voltage vehicle components 15 of the vehicle 2. The electrical system 3 of the vehicle 2 further comprises a number of low voltage batteries 19 connected to the low voltage electrical system 13.

According to embodiments herein, the low voltage electrical system 13 has a nominal voltage within the so-called Voltage Class A, usually abbreviated VCA, namely a nominal voltage lower than 60 volts. Therefore, the low voltage electrical system 13 may also be referred to as a VCA electrical system of the vehicle 2. Likewise, the number of low voltage vehicle components 15 may also be referred to as a number of VCA components.

According to the illustrated embodiments, the vehicle 2 is illustrated as comprising one low voltage vehicle component 15. However, the vehicle 2 may comprise significantly more low voltage vehicle components 15. Purely as examples, the number of low voltage vehicle components 15 may for example comprise one or more of a light emitting component, a driver aid component mounted in a driver environment 60 of the vehicle 2, a climatization component, an air compressor, a servo pump, a DC/DC converter, or the like.

According to the embodiments illustrated in FIG. 2, the electrical system 3 of the vehicle 2 comprises an electric voltage converter 17. The electric voltage converter 17 is connected to the low voltage electrical system 13 as well as to the high voltage electrical system 7. The electric voltage converter 17 may also be referred to as a DC/DC converter. According to these embodiments, the control arrangement 21 may perform the pre-charge of the high voltage electrical system 7 by supplying electricity from the low voltage batteries 19 to the high voltage electrical system 7 via the electric voltage converter 17. The electric voltage converter 17 is configured to increase the voltage inputted from the low voltage batteries 19 to a voltage at, or close to, the operating voltage of the high voltage electrical system 7. In this manner, the pre-charge can be performed in a simple, reliable, and efficient manner without having to connect the number of propulsion batteries 9 to the high voltage electrical system 7.

According to some embodiments, the control arrangement 21 may be configured to, after performing the pre-charge of the high voltage electrical system 7, cause the charging module 23 to operate in a voltage control mode, and then supply electricity from the external electric power source 30 to at least one high voltage vehicle component 5 of the vehicle 2 via the charging module 23. According to these embodiments, the control arrangement 21 may be configured to output a voltage setpoint to the charging module 23. The voltage setpoint may represent a voltage setpoint value at least substantially corresponding to an operating voltage of the high voltage electrical system 7.

In this manner, the least one high voltage vehicle component 5 can be operated in a stable and energy efficient manner using electrical energy from the external electric power source 30. Moreover, the voltage in the high voltage electrical system 7 can be kept substantially constant by the charging module 23 also at varying loads of the number of high voltage vehicle components 5.

According to some embodiments, the control arrangement 21 may operate the at least one high voltage vehicle component 5 of the vehicle 2 using electricity supplied from the external electric power source 30. Moreover, the control arrangement 21 may ensure that the number of propulsion batteries 9 is disconnected from the high voltage electrical system 7 during the supply of electricity from the external electric power source 30 to at least one high voltage vehicle component 5 of the vehicle 2. Furthermore, the control arrangement 21 may ensure that the number of propulsion batteries 9 is disconnected from the high voltage electrical system 7 during operation of the at least one high voltage vehicle component 5 of the vehicle 2 using electricity supplied from the external electric power source 30.

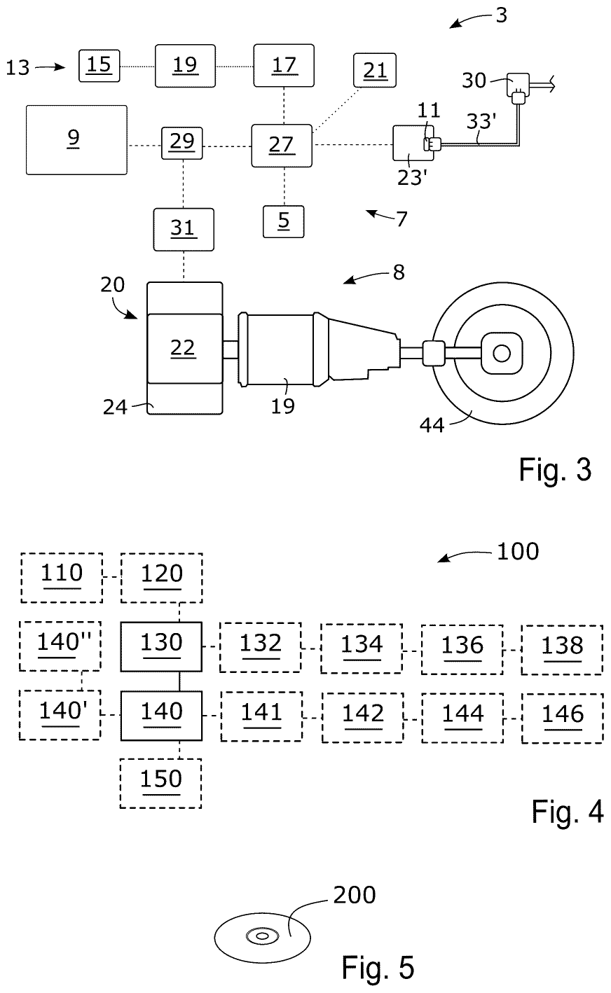

FIG. 3 schematically illustrates the electric propulsion system 8 of the vehicle 2 illustrated in FIG. 1 and an electrical system 3 according to some further embodiments. The vehicle 2 illustrated in FIG. 1 may comprise an electrical system 3 according to the embodiments illustrated in FIG. 3. The electrical system 3 illustrated in FIG. 3 comprises the same features, functions, and advantages as the electrical system 3 illustrated in FIG. 2, with some differences explained below. Below, simultaneous reference is made to FIG. 1 and FIG. 3, if not indicated otherwise.

According to the embodiments illustrated in FIG. 3, the charging module 23′ is comprised in the electrical system 3 of the vehicle 2. In other words, according to the embodiments illustrated in FIG. 3, the charging module 23′ is comprised in, and is arranged on, the vehicle 2.

Also in these embodiments, the electrical connector 11 form part of a charging interface for charging the number of propulsion batteries 9. However, in these embodiments, the electrical connector 11 is arranged on, and/or permanently connected to, the charging module 23′. Moreover, the electrical connector 11 can be connected to an external electric power source 30 using an electric cable 33′. The external electric power source 30 may be configured to supply an alternating current AC, wherein the alternating current AC is supplied to the electrical connector 11 via the electric cable 33′, and wherein the charging module 23′ is configured to convert the alternating current AC to a direct current DC.

Also in these embodiments, the control arrangement 21 may perform a pre-charge of the high voltage electrical system 7 using electricity supplied from the electrical connector 11. According to the embodiments illustrated in FIG. 3, the electricity may be supplied from the electrical connector 11 via the charging module 23′ during the pre-charge procedure.

Moreover, also in these embodiments, the control arrangement 21 may be configured to cause the charging module 23′ to operate in a voltage control mode, and then supply electricity from the external electric power source 30 to at least one high voltage vehicle component 5 of the vehicle 2 via the charging module 23′.

FIG. 4 schematically illustrates a method 100 of managing the supply of electrical energy in a vehicle. The vehicle may be a vehicle 2 according to the embodiments illustrated in FIG. 1. Moreover, the vehicle 2 may comprise an electrical system 3 according to the embodiments illustrated in FIG. 2 or an electrical system 3 according to the embodiments illustrated in FIG. 3. Therefore, below, simultaneous reference is made to FIG. 1-FIG. 4, if not indicated otherwise.

The method 100 is a method of managing the supply of electrical energy in a vehicle 2, wherein the vehicle 2 comprises an electric propulsion system 8 for providing motive power to the vehicle 2, a number of high voltage vehicle components 5, and an electrical system 3, wherein the electrical system 3 comprises:
a high voltage electrical system 7 configured to provide electricity to the electric propulsion system 8 and to the number of high voltage vehicle components 5 during operation of the vehicle 2,
a number of propulsion batteries 9, and
an electrical connector 11,
   wherein the method 100 comprises the steps of, when the electrical connector 11 is electrically connected to an external electric power source 30 and the number of propulsion batteries 9 is disconnected from the high voltage electrical system 7:
performing 130 a pre-charge of the high voltage electrical system 7, and then
supplying 140 electricity from the external electric power source 30 to at least one high voltage vehicle component 5 of the vehicle 2.

As indicated in FIG. 4, the method 100 may comprise the steps of, prior to the step of performing 130 the pre-charge of the high voltage electrical system 7 and the step of supplying 140 electricity from the external electric power source 30 to at least one high voltage vehicle component 5 of the vehicle 2:
detecting 110 if the electrical connector 11 is electrically connected to an external electric power source 30, and
detecting 120 if the number of propulsion batteries 9 is disconnected from the high voltage electrical system 7.

Moreover, as indicated in FIG. 4, the step of performing 130 the pre-charge of the high voltage electrical system 7 may comprise the step of:
performing 132 the pre-charge of the high voltage electrical system 7 by supplying electricity from the external electric power source 30 to the high voltage electrical system 7.

According to some embodiments, the electrical system 3 of the vehicle 2 comprises a low voltage electrical system 13 for providing electricity to a number of low voltage vehicle components 15 of the vehicle 2, a number of low voltage batteries 19 connected to the low voltage electrical system 13, and an electric voltage converter 17, and wherein the step of performing 130 the pre-charge of the high voltage electrical system 7 comprises the step of:
performing 134 the pre-charge of the high voltage electrical system 7 by supplying electricity from the low voltage batteries 19 to the high voltage electrical system 7 via the electric voltage converter 17.

According to some embodiments, the high voltage electrical system 7 comprises a DC link 27, and wherein the step of performing 130 the pre-charge of the high voltage electrical system 7 comprises the step of:
performing 136 the pre-charge of the high voltage electrical system 7 by supplying electricity to the DC link 27.

As indicated in FIG. 4, the method 100 may comprise the step of:
terminating 138 the pre-charging of the high voltage electrical system 7 when a circuit voltage of the high voltage electrical system 7 reaches a predetermined voltage level.

Moreover, as indicated in FIG. 4, the step of supplying 140 electricity from the external electric power source 30 to at least one high voltage vehicle component 5 of the vehicle 2 may comprise the step of:
supplying 141 a voltage to the at least one high voltage vehicle component 5 of the vehicle 2 at a voltage level at least substantially corresponding to an operating voltage of the high voltage electrical system 7.

As indicated in FIG. 4, the step of supplying 140 electricity from the external electric power source 30 to at least one high voltage vehicle component 5 of the vehicle 2 may comprise the steps of:
causing 140′ a charging module 23, 23′ to operate in a voltage control mode, and
supplying 142 electricity from the external electric power source 30 to at least one high voltage vehicle component 5 of the vehicle 2 via the charging module 23, 23′.

The step of causing 140′ the charging module 23, 23′ to operate in a voltage control mode may comprise the step of:
outputting 140″ a voltage setpoint to the charging module 23, 23′.

According to some embodiments, the high voltage electrical system 7 comprises a DC link 27, and wherein the step of supplying 140 electricity from the external electric power source 30 to at least one high voltage vehicle component 5 of the vehicle 2 may comprise the step of:
supplying 144 electricity to the DC link 27 of the high voltage electrical system 7.

Moreover, as is indicated in FIG. 4, the method 100 may comprise the step of:
ensuring 146 that the number of propulsion batteries 9 is disconnected from the high voltage electrical system 7 during the step of supplying 140 electricity from the external electric power source 30 to at least one high voltage vehicle component 5 of the vehicle 2.

Furthermore, as is indicated in FIG. 4, the method 100 may comprise the step of:
operating 150 the at least one high voltage vehicle component 5 of the vehicle 2 using electricity supplied from the external electric power source 30.

It will be appreciated that the various embodiments described for the method 100 are all combinable with the control arrangement 21 as described herein. That is, the control arrangement 21 may be configured to perform any one of the method steps 110, 120, 130, 132, 134, 136, 138, 140′, 140″, 140, , , , 142, 144, 146, and 150 of the method 100.

FIG. 5 illustrates a computer-readable medium 200 comprising instructions which, when executed by a computer, cause the computer to carry out the method 100 according to some embodiments.

According to some embodiments, the computer-readable medium 200 comprises a computer program comprising instructions which, when the program is executed by a computer, cause the computer to carry out the method 100 according to some embodiments. Below, simultaneous reference is made to FIG. 1-FIG. 5, if not indicated otherwise.

The control arrangement 21, as referred to herein, may be comprised in the vehicle 2 and may be operably connected to one or more components of the vehicle 2 and to the charging module 23, 23′ in order to perform the method 100 illustrated in FIG. 4. In FIG. 2 and FIG. 3, the control arrangement 21 is illustrated as operably connected to the DC link 27 of the high voltage electrical system 7. However, as indicated above, the control arrangement 21 may be operably connected to one or more further components and/or systems of the vehicle 2, such as the electrical system 3, the high voltage electrical system 7, the low voltage electrical system 13, one or more components of the electrical system 3, one or more components of the high voltage electrical system 7, one or more components of the low voltage electrical system 13, the number of propulsion batteries 9, the connection devices 29, the electric voltage converter 17, the number of high voltage vehicle components 5, and the electrical connector 11.

One skilled in the art will appreciate that the method 100 of managing the supply of electrical energy in a vehicle 2 may be implemented by programmed instructions. These programmed instructions are typically constituted by a computer program, which, when it is executed in the control arrangement 21, ensures that the control arrangement 21 carries out the desired control, such as the method steps 110, 120, 130, 132, 134, 136, 138, 140′, 140″, 140, 141, 142, 144, 146, and 150 described herein. The computer program is usually part of a computer program product 200 which comprises a suitable digital storage medium on which the computer program is stored.

The control arrangement 21 may comprise a calculation unit which may take the form of substantially any suitable type of processor circuit or microcomputer, e.g., a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 21 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g., a memory card, a flash memory, a USB memory, a hard disc, or another similar volatile or non-volatile storage unit for storing data such as e.g., ROM (Read-Only Memory), PROM (Programmable Read-Only Memory), EPROM (Erasable PROM), EEPROM (Electrically Erasable PROM), etc. in different embodiments.

The control arrangement 21 may be connected to components of the vehicle 2 and of the charging module 23, 23′ for receiving and/or sending input and output signals. These input and output signals may comprise waveforms, pulses, or other attributes which the input signal receiving devices can detect as information and which can be converted to signals processable by the control arrangement 21. These signals may then be supplied to the calculation unit. One or more output signal sending devices may be arranged to convert calculation results from the calculation unit to output signals for conveying to other parts of the vehicle's control system and/or the component or components for which the signals are intended. Each of the connections for receiving and sending input and output signals may take the form of one or more from among a cable, a data bus, e.g., a CAN (controller area network) bus, a MOST (media orientated systems transport) bus or some other bus configuration, or a wireless connection.

In the embodiments illustrated, the vehicle 2 comprises a control arrangement 21 but might alternatively be implemented wholly or partly in two or more control arrangements or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles of the type here concerned are therefore often provided with significantly more control arrangements than depicted in FIG. 2 and FIG. 3, as one skilled in the art will surely appreciate.

The computer program product 200 may be provided for instance in the form of a data carrier carrying computer program code for performing at least some of the method steps 110, 120, 130, 132, 134, 136, 138, 140′, 140″, 140, 141, 142, 144, 146, and 150 according to some embodiments when being loaded into one or more calculation units of the control arrangement 21. The data carrier may be, e.g. a CD ROM disc, as is illustrated in FIG. 5, or a ROM (read-only memory), a PROM (programable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. The computer program product may furthermore be provided as computer program code on a server and may be downloaded to the control arrangement 21 remotely, e.g., over an Internet or an intranet connection, or via other wired or wireless communication systems.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

The wording “substantially constant”, as used herein, may encompass that the aspect referred to varies less than 10%.

The wording “substantially corresponding to”, as used herein, may encompass that the aspects or measurements referred to deviates less than 10% from each other.

1. A method of managing the supply of electrical energy in a vehicle, wherein the vehicle comprises an electric propulsion system for providing motive power to the vehicle, a number of high voltage vehicle components, and an electrical system,
wherein the electrical system comprises:
a high voltage electrical system configured to provide electricity to the electric propulsion system and to the number of high voltage vehicle components during operation of the vehicle,
a number of propulsion batteries, and
an electrical connector,
wherein the method comprises the steps of, when the electrical connector is electrically connected to an external electric power source and the number of propulsion batteries is disconnected from the high voltage electrical system:
performing a pre-charge of the high voltage electrical system, and then
supplying electricity from the external electric power source to at least one high voltage vehicle component of the vehicle.

2. The method according to claim 1, wherein the step of performing the pre-charge of the high voltage electrical system comprises the step of:
performing the pre-charge of the high voltage electrical system by supplying electricity from the external electric power source to the high voltage electrical system.

3. The method according to claim 1, wherein the electrical system of the vehicle comprises a low voltage electrical system for providing electricity to a number of low voltage vehicle components of the vehicle, a number of low voltage batteries connected to the low voltage electrical system, and an electric voltage converter, and wherein the step of performing the pre-charge of the high voltage electrical system comprises the step of:
performing the pre-charge of the high voltage electrical system by supplying electricity from the low voltage batteries to the high voltage electrical system via the electric voltage converter.

4. The method according to claim 1, wherein the step of supplying electricity from the external electric power source to at least one high voltage vehicle component of the vehicle comprises the steps of:
causing a charging module to operate in a voltage control mode, and
supplying electricity from the external electric power source to at least one high voltage vehicle component of the vehicle via the charging module.

5. The method according to claim 1, wherein the method comprises the step of:
ensuring that the number of propulsion batteries is disconnected from the high voltage electrical system during the step of supplying electricity from the external electric power source to at least one high voltage vehicle component of the vehicle.

6. The method according to claim 1, wherein the method comprises the step of:
operating the at least one high voltage vehicle component of the vehicle using electricity supplied from the external electric power source.

7. (canceled)

8. A non-transitory computer-readable medium comprising instructions which, when executed by a computer, cause the computer to carry out the method according to claim 1.

9. A control arrangement configured to manage the supply of electrical energy in a vehicle, wherein the vehicle comprises an electric propulsion system for providing motive power to the vehicle, a number of high voltage vehicle components, and an electrical system,
wherein the electrical system comprises:
a high voltage electrical system configured to provide electricity to the electric propulsion system and to the number of high voltage vehicle components during operation of the vehicle,
a number of propulsion batteries, and
an electrical connector,
wherein the control arrangement is configured to, when the electrical connector is electrically connected to an external electric power source and the number of propulsion batteries is disconnected from the high voltage electrical system:
perform a pre-charge of the high voltage electrical system, and then
supply electricity from the external electric power source to at least one high voltage vehicle component of the vehicle.

10. A vehicle comprising an electric propulsion system for providing motive power to the vehicle, a number of high voltage vehicle components, and an electrical system, wherein the electrical system comprises:
a high voltage electrical system configured to provide electricity to the electric propulsion system and to the number of high voltage vehicle components during operation of the vehicle,
a number of propulsion batteries,
an electrical connector, and
a control arrangement according to claim 9.

11. The vehicle according to claim 10, wherein the high voltage electrical system comprises a DC link, and wherein the control arrangement is configured to perform the pre-charge of the high voltage electrical system by supplying electricity to the DC link.

12. The vehicle according to claim 10, wherein the electrical connector form part of a charging interface for charging the number of propulsion batteries.

13. The vehicle according to claim 10, wherein the number of high voltage vehicle components comprises one or more of:
an electric power take-off component,
a climatization component,
an air compressor,
a servo pump,
a DC/DC converter, and
an electric machine.
